(19) United States
(12) Patent Application Publication
(10) Pub. No.: US 2010/0294856 A1
(43) Pub. Date: Nov. 25, 2010

(54) CONNECTION OF A SPRAY HEAD TO A ROBOT ARM

(75) Inventors: Ulrich Griesenbruch, Heusenstamm (DE); Matthias Krischik, Burghaun (DE)

Correspondence Address: LOWE, HAUPTMAN, HAM & BERNER, LLP (ITW), 1700 DIAGONAL ROAD, SUITE 300, ALEXANDRIA, VA, 22314, US

(73) Assignee: ITW OBERFLAECHENTECHNIK GMBH & CO. KG, Dietzenbach (DE)

(21) Appl. No.: 12/741,677

(22) PCT Filed: Nov. 7, 2008
(86) PCT No.: PCT/EP2008/065111

§ 371 Date: Jul. 16, 2010

(30) Foreign Application Priority Data
Nov. 7, 2007 (DE) 10 2007 053 578.5

(51) Int. Cl. B05B 1/28

(52) U.S. Cl. 239/290; 901/43

(57) ABSTRACT

In an automatic spraying device for coating liquids, which can be attached to a robot for spray-coating objects, the longitudinal axis of the spray nozzle defines a straight center line of the device. The flange surface of a device flange extends transversally to the device center line and can be attached to a robot flange. A tube connection device on the rear side of the spray device is designed in such a manner that all tubes which are necessary for supplying the spray device with liquid or gaseous fluids extend parallel to the device center line from the rear side of the spray device towards the rear into the robot flange. The spray device is preferably constructed in a modular manner.

The invention relates to an automatic spraying device for coating liquid as claimed in claim 1 and to its combination with a robot.

Automatic spraying devices are also referred to as automatic spray guns or spraying guns. An automatic spraying device is known, for instance, from German utility model DE 20 2007 004 372 U1. It can be connected, by an intermediate body extending away from it transversely to its direction of spray, to a robot arm. The intermediate body and the robot arm extend away from the spraying device at right angles to the direction of spray of the spraying device. It is further known to arrange spraying devices on a robot arm, obliquely to their spraying direction, by means of an intermediate body. The robot can be programmed such that it can pivot the spraying device not only transversely to the direction of spray, for instance through 90 degrees or more, but can also rotate about the spray axis, for example through 90 degrees. The rotation of the spraying device about its spray axis is important, in particular, when it has shaping air nozzles which are arranged on diametrically opposing sides of the spray jet so that the round spray jet is compressed into a flat jet by compressed air jets of the shaping air nozzles.

One object of the invention is to provide a facility by which faster positioning of the spray jet relative to the object to be coated is possible.

A further object of the invention is to provide a facility by which the spraying device or parts of the spraying device can be exchanged in a short time.

Yet another object of the invention is to optimize the spraying device such that in the modular construction system several embodiments are possible, using a large number of identical structural elements.

As the basis for the achievement of at least one of these objects, the invention proposes a spraying device having the features of claim 1.

Further features of the invention are contained in the subclaims.

The invention is described below with reference to the appended drawings on the basis of preferred embodiments as examples.

In the drawings:

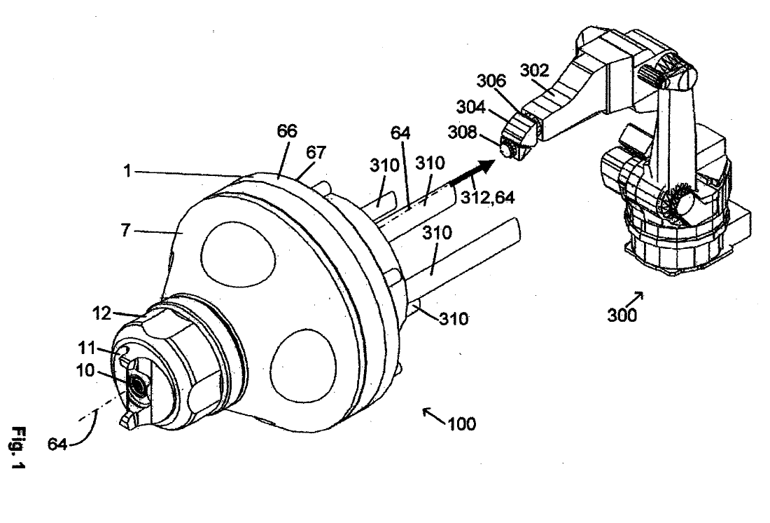

FIG. 1 shows in perspective a first embodiment of an automatic spraying device according to the invention for fastening to a robot arm, preferably to a robot wrist,

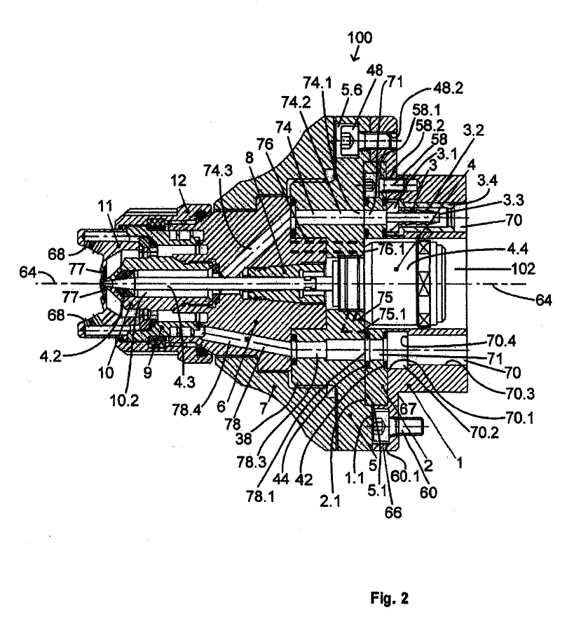

FIG. 2 shows an axial section of the automatic spraying device of FIG. 1,

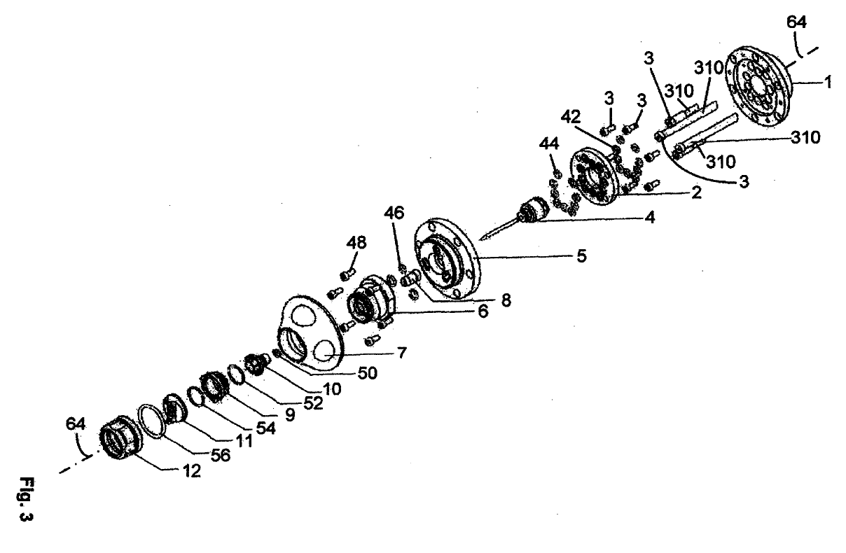

FIG. 3 shows a perspective representation of a plurality of parts of the spraying device of FIG. 1 and FIG. 2,

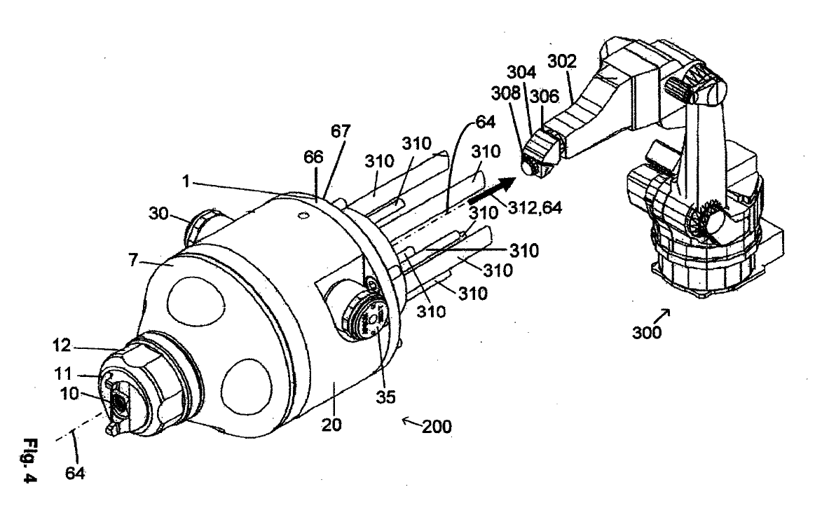

FIG. 4 shows a perspective view of a further embodiment of an automatic spraying device according to the invention for fastening to a robot arm,

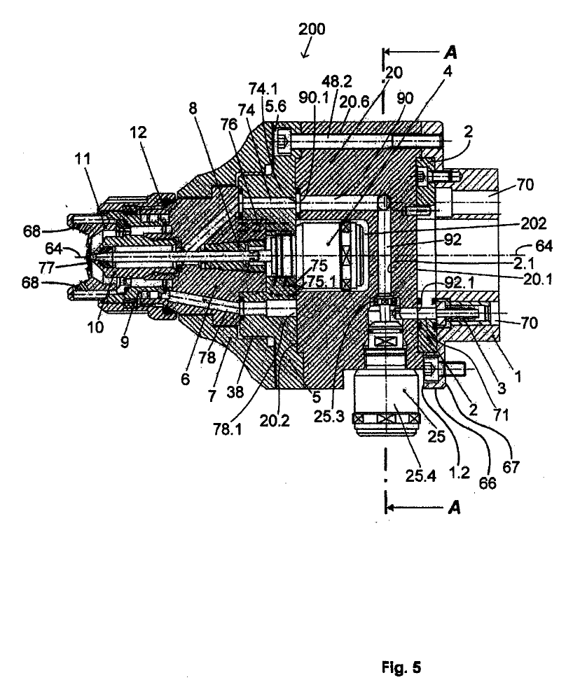

FIG. 5 shows a longitudinal section through the spraying device of FIG. 4,

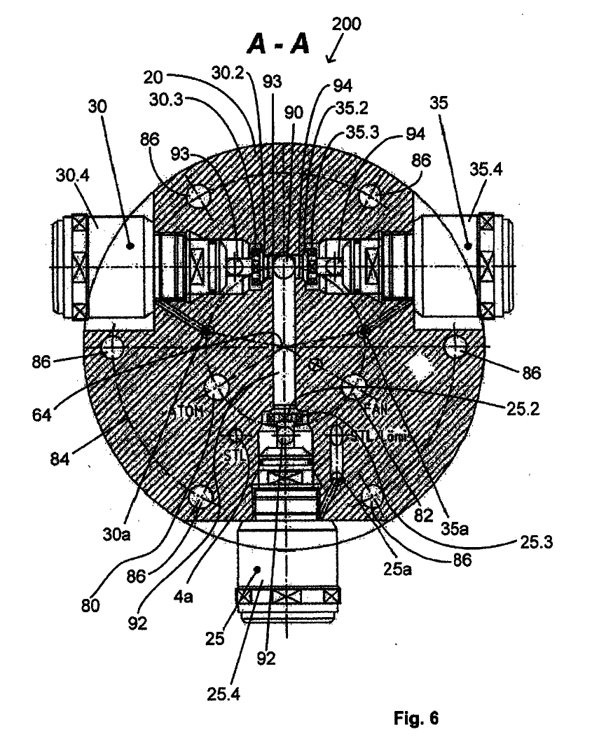

FIG. 6 shows a cross section along the plane A-A of FIG. 5,

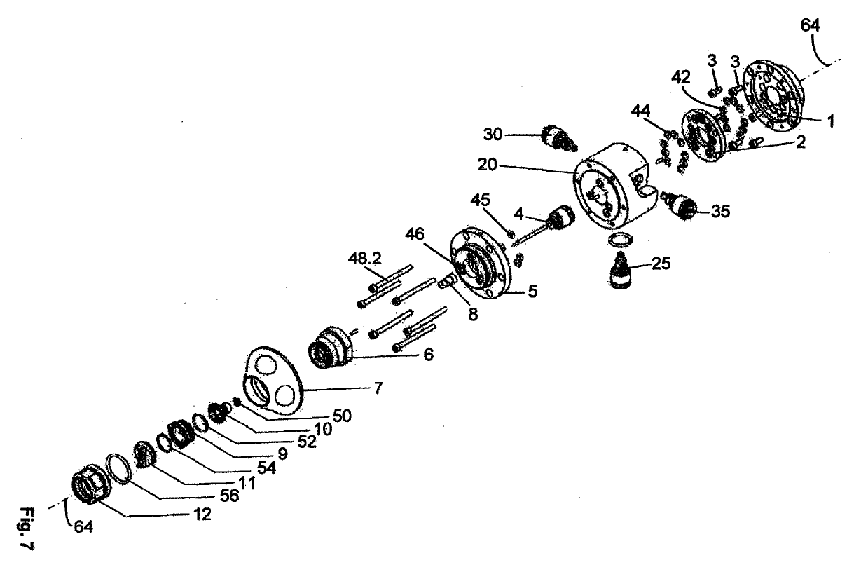

FIG. 7 shows a perspective view of a multiplicity of parts of the spraying device according to FIGS. 4, 5 and 6.

The invention is described below with reference to the embodiment according to FIGS. 1, 2 and 3, in which the spraying device has the following parts: a tube-receiving part 1; a perforated plate 2; a number of tube-connecting elements 3 corresponding to the number of tubes 310 to be connected; a spray nozzle valve 4; a head holder 5; a head part 6; a cap nut 7 on a thread of the head holder 5; a packing seal 8; an air distributor ring 9; a spray nozzle 10; an air cap 11; and a holder ring 12.

By the central longitudinal axis of the spray nozzle 10, a device centerline 64 axial thereto is defined.

The tube-receiving part 1 serves to receive the tube ends of tubes 310 which project out of a robot arm, for example a robot wrist. Each tube end portion is fitted together with a tube-connecting element 3 in the longitudinal direction of the tube.

The spraying device according to FIGS. 1, 2 and 3 preferably also contains the following elements: seals 42, 44, 46, 50, 52, 54, 56 and screws 48 for fastening the head holder 5 to the tube-receiving part 1, the screw head being located on the front side of the head holder 5 and the screw shaft being screwable into an internal thread of the tube-receiving part 1 after the perforated plate 2 has been screwed onto the tube-receiving part 1 by means of further screws 58. The screw heads of these screws 58 are located on the front side of the perforated plate 2 and their screw shaft is screwed into an internal thread 48.2 of the tube-receiving part 1. Since, preferably, all screw heads are arranged in a concealed and preferably recessed manner, the tube-receiving part 1 must be screwed by means of further screws 60 onto a robot flange 308 of a robot arm 302, preferably of a front, movable part 304 of a robot wrist 306 of a robot 300, before the head holder 5 is screwed onto the tube-receiving part 1. The screw heads of these screws 60 are located on the front side of the tube-receiving part 1 and the threaded shaft of these screws 60 is screwable into an internal thread of the robot flange 308.

The further embodiment of an automatic spraying device 200 according to the invention, which is represented in FIGS. 4, 5, 6 and 7, contains the same elements as the embodiment according to FIGS. 1, 2 and 3, which are therefore not listed again here, and additionally a valve block 20 comprising at least two, preferably three or more additional coating liquid valves 25, 30 and 35 for the supply of coating liquid. Of these one can alternatively be used to supply solvent for rinsing of the spraying device. In the valve block 20, a control compressed air duct 25a for supplying control compressed air to one coating liquid supply valve 25 (or solvent supply valve 25), a control compressed air duct 30a for supplying control compressed air to the other additional coating liquid valve 30, and a control compressed air duct 35a for supplying control compressed air to the further coating liquid valve 35 are formed. In addition, in the valve block 20, a control compressed air duct 4a for control compressed air for controlling the spray nozzle 4 is formed. In the valve block 20 there are also formed a duct 80 for atomizing compressed air, a duct 82 for shaping compressed air for the shaping of the spray jet, and on a circumferential circle 84 concentrically around the central device center axis 64, parallel thereto, through bores 86 for the reception of screws 48.2, in place of the screws 48 of FIGS. 1, 2 and 3. Between the valve block 20 and the head holder 5, seals 45 are arranged.

The elements of the two spraying devices 100 and 200 are configured as modules or building blocks, which together form a modular construction system in which all elements of the spraying device 100 are also usable in respect of the spraying device 200. The spraying device 200 contains, in addition to the elements of the spraying device 100, the valve block 20 comprising the additional valves 25, 30 and 35 for the alternative supply of two or more different coating liquids or, in place of one of these coating liquids, for the supply of solvents for cleaning of the spraying device.

The details of the spraying devices 100 and 200 can be realized differently in dependence on requirements in practice.

The basic concepts of the invention are described below on the basis of the two embodiments according to FIGS. 1 to 7.

As a result of the invention, an automatic spraying device 100 or 200 for coating liquid is given, which is fastenable to a robot arm 302, preferably to the movable front arm part 304 of a robot wrist 306, for the coating of objects. Objects are, for instance, car bodies, household appliances, or any other chosen items. The spraying device 100 and 200 respectively contains the spray nozzle 10, which is disposed on the front side of the spraying device 100 and 200 and has a forward-directed nozzle duct 62 for spraying of the coating liquid. The central longitudinal axis of the nozzle duct 10.2 defines a straight device centerline 64. The spray nozzle valve 4 contains, for the closing and opening of the nozzle duct 10.2 of the spray nozzle 10, a valve seat 4.2 and a therewith interacting valve body 4.3, preferably a valve needle, and a valve actuating unit 4.4, which actuates the valve body and valve needle 4.3 and which is arranged axially to the valve needle 4.3 and, as the actuating element, preferably contains a pressure spring (not shown), pressing the valve needle 4.3 into the closing position, and a pressure chamber (not shown) for control compressed air, by means of which the valve body can be moved counter to the spring force in the direction of opening.

The spraying device 100 and 200 further contains, according to the invention, a device flange 66 for fastening the spraying device 100 and 200 to a robot flange 308. The device flange 66 is disposed on the rear side, facing away from the front side, of the spraying device 100 or 200, and is provided with a flange face 67 which points rearward and extends at right angles to the device centerline 64 and annularly surrounds the device centerline 64.

The spraying device 100 or 200 additionally contains a tube-connecting apparatus for all tubes 310 which are necessary to supply the spraying device with liquid and gaseous fluids, in particular with at least one coating liquid and with compressed air, preferably also with solvent. In the represented preferred embodiments of the invention, the tube-connecting apparatus contains the tube-receiving part 1 and the perforated plate 2, between which the tube-connecting elements 3 can be positioned, though the tube-connecting apparatus can also be configured differently. For instance, the tube-connecting apparatus can consist of a one-piece material body, which forms plug-in elements or clamping elements for connection of the tubes, in place of the tube-receiving part 1 and in place of the perforated plate 2 and the tube-connecting elements 3. The tube-connecting apparatus 1, 2, 3 is disposed on the rear side, facing away from the front side, of the spraying device 100 and 200 and is configured to connect and hold the tubes, in a tube longitudinal direction parallel to the device centerline 64, at various locations distributed around the device centerline 64. The tubes extend out from the robot flange 308 and are denoted in FIGS. 1 and 4 with the reference numeral 310. The tube-receiving part 1, the perforated plate 2 and the tube-connecting elements 3 form together with the tubes 310 a tube assembly, which in the arrow direction 312 indicated in FIGS. 1 and 4 can be placed onto the robot flange 308 in order to fasten the device flange 66 to the robot flange 308. The tubes 310 are pushed back into the robot flange 308, and thus also into the robot arm 302, when the tube assembly is placed onto the robot flange. The arrow direction 312 points in the longitudinal direction of the tubes 310, and thus also in the longitudinal direction of the device centerline 64. The inventive concept is hence realized to fasten the spraying device 100 and 200 to a robot arm in such a way that, by the robot wrist 306, over short motional distances, the spray nozzle 10 both can be moved transversely to the device centerline 64 into various positions and can be rotated around the device centerline 64, for instance through at least 90 degrees, in order to change the direction of the shaping air nozzles 68, and thus also the transverse direction of the coating liquid jet deformed into a flat jet by the shaping air. As a result of the described axial alignment of the tube-connecting apparatus 1, 2 and 3 and of the tubes 310 axially parallel and concentrically to the device centerline 64, the control program, and thus the programmability, is simplified, moreover, in relation to the prior art.

The tube-connecting part 1 of the tube-connecting apparatus 1, 2, 3 is disposed on the rear side of the spraying device 100 and 200 concentrically to the device center axis 64 and is provided with a number of tube-connecting means corresponding to the number of tubes.

The tube-connecting part 1 can be of any chosen type. It is preferably a tube-receiving part 1, which has a number of tube-receiving holes 70 corresponding to the number of necessary tubes 310, which tube-receiving holes are arranged distributed around the device centerline 64 and extend parallel to the device centerline 64 fully through the tube-receiving part 1. Each tube-receiving hole 70 is configured to receive respectively a tube 310.

The perforated plate 2 is disposed on the forward-pointing side of the tube-receiving part 1 and is detachably fastened to the tube-receiving part 1 by means of fastening means, for instance latching elements or, preferably, the screws 58. In the perforated plate 2 is formed a number of through holes 71 corresponding to the number of tube-receiving holes 70 of the tube-receiving part 1, of which respectively one through hole is arranged in alignment with one of the tube-receiving holes 70 of the tube-receiving part 1, parallel to the device centerline 64. The through holes 71 have a diameter which preferably is smaller than the diameter of the opposing hole end 70.1 of the tube-receiving hole 70 in alignment therewith in the longitudinal direction of the device centerline 64, or, when a tube-connecting element 3 of the type represented in the drawings is used, is smaller than the outer diameter of that part of a bush-like tube-connecting element 3 insertable into the tube-receiving hole 70 which lies adjacent to the through hole 71. This has the advantage that the perforated plate 2 fastened to the tube-receiving part 1 can prevent the tubes 310 from sliding forward out of the tube-receiving part 1, and also protects the tube ends from damage when the tube-receiving part 1, together with the perforated plate 2, is fastened to the robot flange 308, yet the head holder 5 is not yet fastened to the tube-receiving part 1. This shows that, within the scope of the invention, embodiments are also possible which, though they have a tube-receiving part 1 or some other tube-connecting part 1, have no perforated plate 2.

According to a preferred embodiment of the invention, the tube-receiving holes 70 have a front hole portion 70.2 of widened diameter, so that, between the widened, front hole portion 70.2 and the narrower, rear hole portion 70.3 adjacent thereto, a hole step 70.4 is formed, the step face of which points forward. As a result, in the widened, front hole portion 70.2, a sleeve collar 3.1 of a tube-connecting element 3 can be recessed to the point where it rests on the hole step 70.4, preferably can be fully recessed, when the tube-connecting element 3 is inserted into the particular tube-receiving hole 70 from the front side of the tube-receiving part 1. Extending rearward from the sleeve collar 3.1 is a socket part 3.2 of the tube-connecting element 3, which has a smaller diameter than the sleeve collar 3.1 and is configured for fitting together with a tube 310.

According to one particular embodiment of the invention, the tube-connecting elements 3 are of double-walled configuration and contain a central sleeve-like pin 3.3, having a transversely ribbed outer face for the mounting, respectively, of a tube 310, and an outer sleeve 3.4, so that the tube end of the particular tube 310 is trapped radially between the two sleeves 3.3 and 3.4. A secured plug connection between the particular tube-connecting element 3 and the tube 310 fitted onto it is hence given. The outer sleeve 3.4 holds the tube-connecting element 3 in a substantially wobble-free manner in the tube-receiving hole 70. The perforated plate 2 has at both axial ends of its through holes 70 a seal 42 and 44 respectively, of which one seal 42 bears sealingly against an end face of the particular tube-connecting element 3 and the other seal 44 bears sealingly against a rearward-pointing end face 5.1 of the head holder 5. This rearward-pointing end face 5.1 of the head holder 5 extends at right angles to the device centerline 64.

In the perforated plate 2, through holes 58.1 for receiving respectively one of the screws 58 are formed parallel to the device centerline 64. In the tube-receiving part 1, threaded holes 58.2 are formed parallel to the device centerline 64 and opposite to the through holes 58.1, for fastening of the perforated plate 2 to the tube-receiving part 1 by means of the screws 58. The screws 58 can be put from the front side of the perforated plate 2 through its through holes 58.1 and can be screwed into the threaded holes 58.2 of the tube-receiving part 1 for fastening of the perforated plate 2 to the tube-receiving part 1. The center axes of the through holes 58.1 for the screws 58, and the threaded holes 58.2, respectively extend parallel to the device centerline 64.

The tube-receiving part 1 forms the device flange 66 and the flange face 67 thereof. The flange face 67 extends at right angles to the device centerline 64.

The device flange 66 is provided with through holes 60.1, which extend axially parallel to the device centerline 64 through the flange 66, for the reception respectively of one of the screws 60 for fastening of the device flange 66 to the robot flange 308 by means of the screws 60. The screw heads of the screws 60 are located on the front side of the device flange 66, so that they can be screwed from the front onto the robot flange 308.

The spray nozzle 10 is disposed at the front end of a structural unit 5, 6, which can be a single-piece part or can consist of a plurality of parts, and preferably contains the head part 6 and the head holder 5, which are disposed one behind the other in the longitudinal direction of the device centerline 64. The rear end of the structural unit 5, 6, which in the preferred embodiment is the rear end face 5.1 of the head holder 5, is detachably connected to the tube-connecting apparatus 1, 2, 3 and extends preferably at right angles to the device centerline 64. All fluid ducts which are necessary for the supply of coating liquid to the spray nozzle 10 and for the supply of control compressed air for actuation of the spray nozzle valve 4 extend through this structural unit 5, 6. The cap nut tensions the head part 5 in the longitudinal direction of the device centerline 64 axially against the head holder 5.

Extending through the structural unit 5, 6 is a fluid duct 74, whereof an upstream portion 74.3 is formed in the head holder 5 and a downstream portion 74.4 in the head part 6, for supplying a coating liquid to the upstream side of the valve seat 4.2 of the spray nozzle valve 4. A fluid duct 75 for supplying control compressed air to the actuating unit 4.4 for actuation of the spray nozzle valve 4 extends preferably only through the head holder 5. Preferably also extending through the structural unit 5, 6 is a fluid duct 76, which in the represented embodiment extends through the head holder 5 and through the head part 6, for supplying atomizing compressed air to at least one atomizing air opening 77, which emerge(s) from the spraying device 100 or 200 to the front, adjacent to the nozzle duct 10.2 of the spray nozzle 10. In FIGS. 2 and 5, the fluid duct 76 is shown purely schematically in dashed representation, since it is located in a different cross-sectional plane than the represented sectional plane. It is configured similarly, for connection to one of the tube-receiving holes 70, to the fluid ducts 74 and 78. The fluid duct extends through the structural unit 5, 6, an upstream portion 78.3 being formed in the head holder 5 and a downstream portion 78.4 in the head part 6, to supply shaping compressed air to the shaping compressed air outlets 68 for the shaping of the spray jet, preferably for the shaping of a flat spray jet from a spray jet of round cross section. Depending on the application, the shaping compressed air outlets 68 and, if need be, also the fluid duct 78 for shaping compressed air, can be omitted.

Each of these fluid ducts 74, 75, 76 and 78 for coating liquid, control compressed air, atomizing compressed air and shaping compressed air has a duct inlet opening 74.1 and 75.1 and 76.1 and 78.1, which is formed in the rearward-pointing end face 5.1 of the structural unit 5, 6 and is respectively arranged in alignment with another of the tube-receiving holes 70 of the tube-receiving part 1 in the longitudinal direction of the device centerline 64, parallel to the device centerline 64.

According to one particular embodiment of the invention, instead of the fluid duct 76 for atomizing compressed air and the fluid duct 78 for shaping compressed air, only one of the two can be provided, for example the fluid duct 78, such that its compressed air is divided at the downstream duct end into atomizing compressed air and shaping compressed air.

The cap nut 7 is screwed from the front onto the thread 38 of the head holder 5 and tensions the head part 6 in the longitudinal direction of the device centerline 64 against the head holder 5.

Although the perforated plate 2 is advantageous, in some embodiments of the invention it can also be omitted. In this case, the tube-receiving holes 70 of the tube-receiving part 1, at least, however, the tube-connecting elements 3, extend as far as the rear end face 5.1 of the head holder 5, preferably with seals therebetween.

In the embodiment of the spraying device 100 of FIGS. 1, 2 and 3, the head holder 5 is arranged, in the longitudinal direction of the device centerline 64, adjacent to the tube-connecting apparatus 1, 2, 3 and is detachably connected thereto, preferably by means of the screws 48. The spraying devices 100 and 200 of FIGS. 1 to 3 and FIGS. 4 to 7 consist of individual modules or structural units in said manner. As a result, for the formation of the spraying device 200 of FIGS. 4 to 7, all elements or modules of the spraying device 100 of FIGS. 1, 2 and 3 can be used, to which only the valve block 20 comprising the additional valves 25, 30 and 35 needs to be added, and, in place of the short screws 48, the longer screws 48.2 shall be used.

The valve block 20 is clamped in the longitudinal direction of the device centerline 64 in a fluid-tight manner between the rearward-pointing end face 5.1 of the head holder 5 and the tube-connecting apparatus 1, 2, 3, for instance against a, with respect to the device centerline 64, radial front end face 2.1 of the perforated plate 2, and against a likewise radial front end face 1.1 of the tube-receiving part 1.

In the valve block 20 are formed fluid passage ducts for connecting all the tube-receiving holes 70 of the tube-receiving part 1, or for connecting all the through holes 71 in the preferred use of the perforated plate 2, to the particular fluid ducts 74, 75, 76 and 78 of the structural unit 5, 6, with the peculiarity that, alternatively, different coating liquids can be supplied to the spray nozzle 10 by at least two different tubes 310 and tube-connecting holes 70. According to the described preferred embodiment, the supply of respectively one of three different coating liquids through respectively one of the three additional control valves 25, 30 or 35 is possible. In place of the supply of one of the coating liquids, one of the additional valves 25, 30 or 35 can also be used to supply solvent to the spray nozzle 10.

In the valve block 20 of the preferred embodiment, a fluid-collecting duct 90 is formed, which at its downstream end has a duct opening 90.1 which emerges in a front end face 20.2, extending radially to the device centerline 64, of the valve block 20, and lies opposite the upstream duct opening 74.1 of the fluid duct 74 for the coating liquid in the structural unit 5, 6 in the longitudinal direction of the device centerline 64, parallel to the latter.

In the fluid-collecting duct 90 emerge at least two, according to the preferred embodiment three fluid supply ducts 92, 93 and 94, which respectively can be selectively closed off and opened by one of the three additional valves 25 and 30 and 35 and have on the upstream side of the additional valve 92, 93 and 94 a duct inlet opening 92.1 and 93.1 and 94.1 (93.1 and 94.1 are not visible in the drawings), which respectively emerge in the rearward-pointing end face 20.1 of the valve block 20 and are respectively arranged lying opposite another of the tube-receiving openings 70, and thus also respectively opposite another of the through holes 71 of the perforated plate 2 in the longitudinal direction of the device centerline 64, parallel to the latter. In each of these fluid supply ducts 92, 93, 94 there is a valve seat 25.2 and 30.2 and 35.2, which can be closed off by a valve body 25.3 and 30.3 and 35.3. For actuation of its valve body 25.3, 30.3 and 35.3, each additional valve 25, 30 and 35 contains a valve actuating unit 25.4 and 30.4 and 35.4. This preferably contains a spring (not shown), which presses the associated valve body into the closing position, and a pressure chamber (not shown) for control compressed air for moving the particular valve body in the valve opening direction.

For the supply of the control compressed air to the actuating units 25.4, 30.4 and 35.4, in the valve block 20 are formed the control air ducts 25a, 30a and 35a. Also formed in the valve block are a duct 4a for the control compressed air of the spray nozzle valve 4, the duct 80 for the atomizing compressed air of the atomizing air outlet opening or openings 77, and the duct 82 for shaping compressed air for the shaping air outlets 68, all of these ducts formed in the valve block 20 respectively having on their upstream side an adjacent duct opening in alignment with one of the tube-connecting holes 70, and at their downstream end a duct opening in alignment with one of the ducts of the structural unit 5, 6. These are not all visible in the drawings, since they lie in different cross-sectional planes. In this way, the shaping air duct 82, for instance, connects a tube-receiving hole 70 of the tube-receiving part 1 to the fluid duct 78 of the structural unit 5, 6, and the control air duct 4a of the valve block 20 connects one of the tube-receiving holes 70 to the inlet duct opening 75.1 of the fluid duct 75 for the control compressed air of the spray nozzle valve 4. The other connections are also formed in a similar manner.

The tube-connecting apparatus 1, 2, 3 preferably has axially to the device centerline 64 a central cavity 102, which at least on the front side of the tube-connecting apparatus 1, 2, 3 is open and the inner diameter of which is at least as large as the outer diameter of the actuating unit 4.4 for actuation of the valve body 4.3 of the spray nozzle valve 4, so that this actuating unit 4.4 can project into the central cavity 102. The cavity 102 can be a blind hole or, preferably, a through hole.

The valve block 20 preferably has axially to the device centerline 64 a central cavity 202, which at least on the front side of the valve block 20 is open and the inner diameter of which is at least as large as the outer diameter of the actuating unit 4.4 for actuation of the valve body 4.3 of the spray nozzle valve 4, so that this actuating unit 4.4 can project into the central cavity 202. The cavity 202 can be a through hole or, preferably, a blind hole.

The invention offers a modular construction system comprising a plurality of modules with which various embodiments can advantageously be formed.

1. An automatic spraying device for spray-coating objects, comprising:
a spray nozzle, which is disposed on a front side of the spraying device and has a forward-directed nozzle duct for spraying of the coating liquid, the central longitudinal axis of the nozzle duct defining a straight device centerline;
a spray nozzle valve for closing and opening the nozzle duct;
a device flange for fastening the spraying device to a robot flange of a robot arm, the device flange being disposed on a rear side, facing away from the front side, of the spraying device and having a flange face which points rearward and extends at right angles to the device centerline and annularly surrounds the device centerline;
a tube-connecting apparatus for all tubes which are necessary to supply the spraying device with at least one coating liquid and with compressed air, the tube-connecting apparatus being disposed on the rear side, facing away from the front side, of the spraying device and having connecting openings for connecting and holding the tubes, in a tube longitudinal direction parallel to the device centerline, at various locations distributed around the device centerline.

2. The spraying device as claimed in claim 1, wherein the tube-connecting apparatus has a tube-receiving part, which is disposed on the rear side of the spraying device concentrically to the device centerline and has a multiplicity of tube-connecting holes, which are arranged distributed around the device centerline and extend parallel to the device centerline fully through the tube-receiving part for the connection respectively of a tube, wherein the tube-connecting holes form at least a portion of the connecting openings.

3. The spraying device as claimed in claim 2, wherein
the tube-connecting apparatus has a perforated plate, which is disposed on the forward-pointing side of the tube-receiving part and is detachably fastened to the tube-receiving part by means of fastening means,
the perforated plate has through holes, each of which is arranged respectively in alignment with one of the tube-receiving holes of the tube-receiving part, parallel to the device centerline, and has a diameter which is smaller than the diameter of the opposing hole end of the tube-receiving hole arranged in alignment therewith in the longitudinal direction of the device centerline, or is smaller than the outer diameter of a bush-like tube-connecting element insertable into the tube-receiving hole.

4. The spraying device as claimed in claim 3, wherein the tube-receiving holes have a front hole portion of widened diameter, and
between the widened, front hole portion and the narrower, rear hole portion adjacent thereto, a forward-pointing hole step is formed, so that in the widened, front hole portion a sleeve collar of a tube-connecting element can be recessed to the point where it rests on the hole step, preferably can be fully recessed, when the tube-connecting element is inserted into the particular tube-receiving hole from the front side of the tube-receiving part,
wherein a sleeve collar is formed at the front end of the tube-connecting element and a sleeve shaft extends rearward from the sleeve collar, which sleeve shaft has a smaller diameter than the sleeve collar.

5. The spraying device as claimed in claim 3, wherein
in the perforated plate, parallel to the device centerline, through holes are formed for the reception of screws, and, lying opposite them in the longitudinal direction of the device centerline, in the tube-receiving part, threaded holes are formed for screwing in of the screws for fastening the perforated plate to the tube-receiving part from the front side of the perforated plate 2,
wherein the screw heads of the screws are located on the front side of the perforated plate 2, and the center axes of the through holes for the screws and the threaded holes extend parallel to the device centerline.

6. The spraying device as claimed in claim 2, wherein the tube-receiving part forms the device flange and the flange face thereof.

7. The spraying device as claimed in claim 1, wherein the device flange has through holes, which pass fully through it axially parallel to the device centerline, for the reception of screws for fastening the device flange to a robot flange.

8. The spraying device as claimed in claim 1, wherein the spray nozzle is disposed at the front end of a structural unit, the rear end of which is connectable to the tube-connecting apparatus and through which extend at least one of
a fluid duct for supplying a coating liquid to the upstream side of the spray valve,
a fluid duct for supplying control compressed air for actuation of the spray nozzle valve,
a fluid duct for supplying atomizing compressed air to at least one atomizing compressed air outlet, and
a fluid duct for supplying shaping compressed air to shaping compressed air outlets for the shaping of a flat spray jet from a spray jet of round cross section,
wherein each of these fluid ducts has a duct inlet opening, which is formed in a rearward-pointing end face of the structural unit and is respectively arranged in alignment with another of the tube-receiving holes of the tube-receiving part in the longitudinal direction of the device centerline, parallel to the device centerline.

9. The spraying device as claimed in claim 8, wherein the structural unit has a circular outer shape configured concentrically to the device centerline and is arranged concentrically to the device centerline.

10. The spraying device as claimed in claim 9, wherein the structural unit has a head part, and a head part holder arranged behind the head part in the longitudinal direction of the device centerline.

11. The spraying device as claimed in claim 9, wherein the rear end of the structural unit is arranged adjacent to the tube-connecting apparatus in the longitudinal direction of the device centerline and is detachably connected thereto.

12. The spraying device as claimed in claim 9, wherein
a valve block is arranged axially to the device centerline between the structural unit and the tube-connecting apparatus,
in the valve block are formed fluid ducts for connecting the fluid ducts of the structural unit to the relevant connecting openings of the tube-connecting apparatus,
wherein in the valve block are integrated at least two additional valves for the alternative flow connection of respectively one of at least two connecting openings of the tube-connecting apparatus to a fluid-collecting duct formed in the valve block, which fluid-collecting duct has an orifice which emerges in a forward-pointing valve block face and is adjacent to and lies opposite a rearward-pointing duct opening of the fluid duct for coating liquid in a longitudinal direction parallel to the device centerline, which fluid duct extends from this duct opening to the upstream side of a valve seat of the spray nozzle valve.

13. The spraying device as claimed in claim 12, wherein the valve block is clamped between the structural unit and the tube-connecting apparatus in the longitudinal direction of the device centerline, preferably by means of screws which can be put from a front side of the structural unit through bores in the structural unit and through bores in the valve block and can be screwed into threaded holes formed in the tube-connecting apparatus, wherein the screw head of the screws is respectively located on the front side of the structural unit.

14. The spraying device as claimed in claim 1, wherein the tube-connecting apparatus has axially to the device centerline a central cavity, which at least on the front side of the tube-connecting apparatus is open and the inner diameter of which is at least as large as the outer diameter of an actuating unit for actuation of a valve body of the spray nozzle valve, so that this actuating unit can project into the central cavity.

15. The spraying device as claimed in claim 12, wherein the valve block has axially to the device centerline a central cavity, which at least on the front side of the valve block is open and the inner diameter of which is at least as large as the outer diameter of an actuating unit for actuation of a valve body of the spray nozzle valve, so that this actuating unit can project into the central cavity.

16. A combination of a spraying device as claimed in claim 1, wherein the device flange of the spraying apparatus is detachably fastened to a robot flange of the robot.

17. The combination as claimed in claim 16, wherein the robot flange is provided on the movable front portion of a robot wrist.
